(19) United States
(12) Patent Application Publication
(10) Pub. No.: US 2025/0114775 A1
(43) Pub. Date: Apr. 10, 2025

(54) PROCESS FOR THE PREPARATION OF [RU(OAC)2(LIGAND)] CATALYSTS

(71) Applicant: Hoffmann-La Roche Inc., Little Falls, NJ (US)

(72) Inventors: Kurt PUENTENER, Kaiseraugst (CH); Etienne TRACHSEL, Basel (CH)

(73) Assignee: Hoffmann-La Roche Inc., Little Falls, NJ (US)

(21) Appl. No.: 18/984,468

(22) Filed: Dec. 17, 2024

Related U.S. Application Data
(63) Continuation of application No. PCT/EP2023/068143, filed on Jul. 3, 2023.

(30) Foreign Application Priority Data
Jul. 4, 2022 (EP) 22182871.8

(51) Int. Cl. B01J 31/24; B01J 31/22; B01J 37/02; B01J 37/03; B01J 37/06; B01J 37/08; C07F 15/00

(52) U.S. Cl. CPC B01J 31/2409; B01J 31/2208; B01J 37/0236; B01J 37/031; B01J 37/06; B01J 37/08; C07F 15/0053; B01J 2231/60; B01J 2531/004; B01J 2531/821

(57) ABSTRACT

The invention comprises a process for the preparation of a [Ru(OAc)₂(Ligand)] catalysts of the formula I

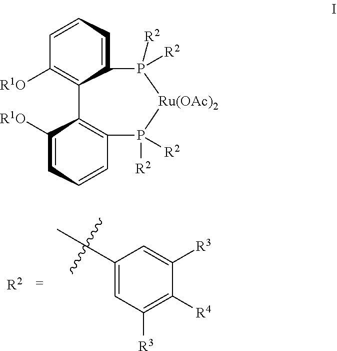

wherein R¹ is C₁₋₆ alkyl and R³ is hydrogen or C₁₋₆ alkyl and R⁴ is hydrogen or C₁₋₆-alkoxy.

[Ru(OAc)₂(Ligand)] catalysts are versatile hydrogenation catalysts.

The invention relates to a novel process for the preparation of [Ru(OAc)₂(Ligand)] catalysts of the formula I and its enantiomers

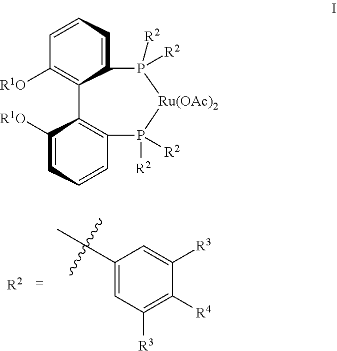

wherein R¹ is C₁₋₆ alkyl and R³ is hydrogen or C₁₋₆ alkyl and R⁴ is hydrogen or C₁₋₆-alkoxy.

[Ru(OAc)₂(Ligand)] catalysts are versatile hydrogenation catalysts, which are successfully applied on commercial scale enantioselective hydrogenations in the synthesis of intermediates for pharmaceutically active compounds (European Patent Application EP 1127886 A1).

Object of the present invention was to provide an alternative method for the scalable manufacture of [Ru(OAc)₂(Ligand)] catalysts in high purities and yields.

It was found that the object could be achieved with the process for the preparation of a [Ru(OAc)₂(Ligand)] catalysts of the formula I

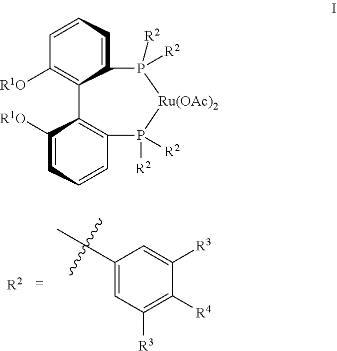

wherein R¹ is C₁₋₆ alkyl and R³ is hydrogen or C₁₋₆ alkyl and R⁴ is hydrogen or C₁₋₆-alkoxy, which comprises the conversion of a phosphine precursor of the formula II

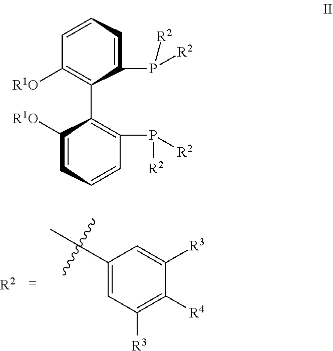

wherein R¹, R³ and R⁴ are as above,
with [Ru(OAc)₂(p-cymene)], wherein Ac stands for acetyl,
in the presence of a non-polar solvent at a reaction temperature of 40° C. to 110° C.

The following definitions are set forth to illustrate and define the meaning and scope of the various terms used to describe the invention herein.

The term C₁₋₆-alkyl stands for a linear or branched alkyl group of 1 to 6 C-atoms. Representatives are methyl, ethyl, n-propyl, i-propyl, n-butyl, i-butyl or t-butyl, pentyl and its isomers and hexyl and its isomers.

The term C₁₋₆-alkoxy stands for a linear or branched alkyl group of 1 to 6 C-atoms attached to an oxygen atom. Representatives are methoxy, ethoxy, n-propoxy, i-propoxy, n-butoxy, i-butoxy or t-butoxy, pentyloxy and its isomers and hexyloxy and its isomers.

In a preferred embodiment R¹ is C₁₋₄-alkyl, more preferably, methyl, R³ C₁₋₄-alkyl, more preferably is t-butyl and R⁴ is hydrogen or C₁₋₄-alkoxy, more preferably hydrogen or methoxy.

The phosphine precursor of the formula II

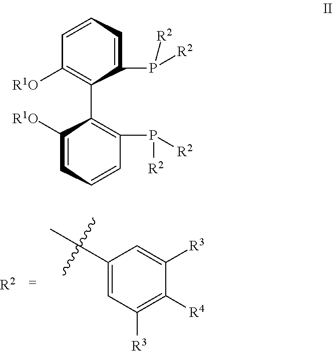

wherein R¹, R³ and R⁴ are as above, are commercially available, e.g. from Solvias SigmaAldrich or Strem.

Preferred starting materials are the compounds
(R)-3,5-tBu-4-MeO-MeOBIPHEP (CAS #352655-61-9), i.e. the compound of formula II, wherein R¹ is methyl, R³ is t-butyl and R⁴ is methoxy and or
(R)-3,5-tBu-MeOBIPHEP (CAS #192138-05-9), i.e. the compound of formula II, wherein R¹ is methyl, R⁴ is hydrogen and R³ is t-butyl.
(R)-MeOBIPHEP (CAS #133545-16-1), i.e. the compound of formula II, wherein R¹ is methyl, R⁴ and R³ are hydrogen.

[Ru(OAc)₂(p-cymene)] is as rule readily prepared from commercially available [RuCl₂(p-cymene)]₂ (CAS #52462-29-0) in analogy to the literature ((a) M. A. Bennett et al. J. Chem. Soc. Dalton Trans. 1983, 1571-1581, b.) P. H. Dixneuf et al., Green Chem. 2011, 13, 3075-3078), respectively synthesized as described in Examples 1.1 and 1.2.

As outlined above the process is performed in presence of a non-polar solvent.

Suitable non-polar solvents can be selected from tetrahydrofuran, toluene, benzene, 1,4-dioxane, 2-methyltetrahydrofuran, but preferably 2-methyltetrahydrofuran is used.

The upper limit of the reaction temperature is typically determined by the boiling temperature of the chosen non-polar solvent, which is 110° C. for toluene. The lower limit can be chosen at 40° C.

For the preferred solvent 2-methyltetrahydrofuran the reaction temperature is preferably selected between 40° C. and 80° C., more preferably between 70° C. and 80° C.

The reaction is typically run under inert gas atmosphere. Argon is the inert gas commonly used.

A conversion of about 90-95%, checked via ³¹P-NMR, can as a rule be reached after about 24-40 h reaction time.

The [Ru(OAc)₂(Ligand)] catalyst of the formula I can be isolated form the reaction mixture by methods known to the skilled in the art, for instance by removing the solvent and drying the catalyst under vacuum at room temperature.

In a preferred embodiment of the present invention the isolation from the reaction mixture takes place via a solvent swap or a solvent exchange, wherein the non-polar solvent used in the reaction is replaced by an anti-solvent, i.e. a solvent wherein the catalyst is not soluble.

Suitable anti-solvents can be selected from linear or branched C₅₋₁₀ alkanes, preferably from n-pentane, n-hexane or n-heptane, more preferably from n-hexane.

In a first step the reaction mixture is concentrated under vacuum.

Thereafter, the anti-solvent is added and the mixture is concentrated under vacuum, as a rule at room temperature

Further cycles, comprising anti-solvent addition and subsequent concentration may follow, until the non-polar solvent is completely removed.

Two cycles have been found as sufficient to remove the preferred non-polar solvent 2-methyltetrahydrofuran.

Eventually the catalyst precipitates and can be filtered off. The filter cake, after washing with the anti-solvent, can then be dried under vacuum, typically at room temperature.

With this preferred isolation procedure the [Ru(OAc)₂(Ligand)] catalyst of the formula I can be obtained in yield of up to 77% and very high purities of up >99.5% with close to 0 wt % of residual non-polar solvents.

### EXAMPLES

Abbreviations:

| | |
|---|---|
| MeTHF | 2-Methyl-tetrahydrofuran |
| DCM | Dichloromethane |
| n-Hexane | Hexane |
| rt | room temperature |
| [RuCl₂(p-cymene)]₂ | Dichloro(p-cymene)ruthenium(II) dimer, |
| | CAS # 52462-29-0, commercially available |
| | from Strem Chemicals Ltd. |
| [Ru(OAc)₂(p-cymene)] | Diacetato(p-cymene)ruthenium(II), was |
| | synthesized in analogy to M.A. Bennett et |
| | al. J. Chem. Soc. Dalton Trans. 1983, 1571- |
| | 1581, b P. H. Dixneuf et al., Green Chem. |
| | 2011, 13, 3075-3078 |
| (R)—MeOBIPHEP | (R)-(+)-(6,6′-Dimethoxybiphenyl-2,2′- |
| | diyl)bis(diphenylphosphine), CAS # |
| | 133545-16-1 commercially available from |
| | Solvias AG |
| (R)-3,5-tBu-4-MeO—MeOBIPHEP | (R)-(6,6′-Dimethoxybiphenyl-2,2′- |
| | diyl)bis[bis(3,5-di-tert-butyl-4- |
| | methoxyphenyl)phosphine], CAS # |
| | 352655-61-9, commercially available |
| | from Solvias AG |
| (R)-3,5-tBu—MeOBIPHEP | (R)-(6,6′-Dimethoxybiphenyl-2,2′- |
| | diyl)bis[bis(3,5-di-tert-butyl- |
| | phenyl)phosphine], CAS # 192138-05-9, |
| | commercially available from Solvias AG |
| [Ru(OAc)₂((R)—MeOBIPHEP)] | Diacetato[(R)-(6,6′-dimethoxybiphenyl- |
| | 2,2′-diyl)bis(diphenylphosphine)] |
| | ruthenium(II |
| [Ru(OAc)₂((R)-3,5-tBu-4-MeO—MeOBIPHEP)] | Diacetato[(R)-(6,6′-dimethoxybiphenyl- |
| | 2,2′-diyl)bis[bis(3,5-di-tert-butyl-4- |
| | methoxyphenyl)phosphine]]ruthenium(II) |
| [Ru(OAc)₂((R)-3,5-tBu—MeOBIPHEP)] | Diacetato[(R)-(6,6′-dimethoxybiphenyl- |
| | 2,2′-diyl)bis[bis(3,5-di-tert-butyl- |
| | phenyl)phosphine]]ruthenium(II) |

### Example 1

### Synthesis of [Ru(OAc)₂(p-cymene)]

### Example 1.1

Under argon atmosphere, a 2-L round bottomed flask topped with an argon inlet and a Teflon-coated stirring bar was charged with [RuCl₂(p-cymene)]₂ (82.5 g, 0.14 mol) and silver acetate (98.9 g, 0.59 mol). Toluene (750 mL) was added and the resulting yellow-brown suspension was stirred at rt for 23 h (complete conversion determined by ¹H-NMR spectroscopy). DCM (100 mL) was added and the suspension was filtered over a high porosity glass sintered filter (P3) covered with a 2-cm pad of pressed filter flocs (MN2101, Macherey-Nagel). The filter cake was rinsed with DCM (300 mL) and the combined filtrates were evaporated to dryness at 50 mbar/45° C. The dark red residue was dissolved in DCM (150 mL) and filtered over a high porosity glass sintered filter (P3) covered with a 2-cm pad of pressed filter flocs. The filter cake was rinsed with DCM (75 mL). To the combined filtrates, hexane (100 mL) was added and the solution concentrated at 400 mbar/35° C. to approx. half-volume. Hexane (100 mL) was added and the solution concentrated at 400 mbar/35° C. to approx. half-volume. This operation was repeated once to remove residual DCM, respectively to precipitate the product. The formed suspension was stirred at rt for 30 min and the light yellow supernatant was removed by suction with a tube equipped with a filter candle. The crystalline residue was washed with hexane (600 mL) in 3 portions whereby the supernatant was each time removed by suction with a tube equipped with a filter candle. The residue was dried overnight at 1 mbar/rt to yield the title compound (86.7 g, 91%) as a yellow-brown powder.

### Example 1.2

Under argon atmosphere, a 100-mL round bottomed flask topped with an argon inlet and a Teflon-coated stirring bar was charged with [RuCl₂(p-cymene)]₂ (5.0 g, 8.2 mmol) and potassium acetate (4.0 g, 40.8 mmol). Toluene (50 mL) was added and the resulting red suspension was stirred at rt for 24 h (complete conversion determined by ¹H-NMR spectroscopy). DCM (20 mL) was added and the suspension was filtered over a high porosity glass sintered filter (P3) covered with a 2-cm pad of pressed filter flocs (MN2101, Macherey-Nagel). The filter cake was rinsed with DCM (80 mL) and the combined filtrates were evaporated to dryness at 50 mbar/50° C. MeTHF (25 mL) were added to the dark red residue and the mixture was heated to 75° C. for 15 min to yield a dark red solution. After cooling to rt, the formed suspension was stirred in an ice bath for 30 min and the crude product was filtered off on a high porosity glass sintered filter (P3). The filter cake was washed with cold MeTHF (5 mL) and dried overnight at 1 mbar/rt to yield the title compound (5.0 g, 86%) as a yellow-brown powder.

¹H-NMR (400 MHZ, CDCl₃): δ (ppm) 5.80 (d, J=5.9 Hz, 2H), 5.58 (d, J=6.2 Hz, 2H), 2.86 (spt, J=6.9 Hz, 1H), 2.26 (s, 3H), 1.93 (s, 6H), 1.36 (d, J=6.7 Hz, 6H)

### Example 2

### Synthesis of [Ru(OAc)₂((R)-3,5-tBu-4-MeO-MeOBIPHEP)]

Under argon atmosphere, a 250-mL Schlenk flask equipped with a reflux condenser topped with an argon inlet and a Teflon-coated magnetic stirring bar was charged with of (R)-3,5-tBu-4-MeO-MeOBIPHEP (10.0 g, 8.68 mmol) and [Ru(OAc)₂(p-cymene)] (3.1 g, 8.68 mmol. MeTHF (80 mL) was added and the resulting brown suspension was stirred at 85° C. (jacket temperature) for 40 h to reach a conversion of 91% (determined by ³¹P-NMR spectroscopy). The reaction mixture was allowed to cool to rt and concentrated at 100-300 mbar to a volume of 30-40 mL. Hexane (40 mL) was added, the resulting brown solution was cooled in an ice bath and filtered over a high porosity glass sintered filter (P3) covered with a 2-cm pad of pressed filter flocs (MN2101, Macherey-Nagel). The filter cake was rinsed with hexane (25 mL) and the combined filtrates were concentrated at 100-300 mbar/rt to a volume of 30-40 mL. Another portion of hexane (40 mL) was added and the resulting solution was concentrated at 100-300 mbar/rt to a volume of 30-40 mL to remove residual MeTHF. Subsequently, hexane (40 mL) was added and the formed suspension was stirred overnight at rt, then cooled in an ice bath, stirred for 1 h and filtered off on a high porosity glass sintered filter (P3). The filter cake was rinsed with hexane (20 mL) and dried for 4 h at 0.05-0.1 mbar/rt to yield the title compound (9.2 g, 77%) as an orange solid with >99% purity (determined by ³¹P-NMR).

³¹P-NMR (162 MHz, CDCl₃): δ (ppm) 66.6 (s). Residual solvents: MeTHF (0.03 wt % (GC)), hexane (0.11 wt % (GC)), H₂O (<0.1 wt % (Karl Fischer)).

### Example 3

### Synthesis of [Ru(OAc)₂((R)-3,5-tBu-MeOBIPHEP)]

Under argon atmosphere, a 250-mL Schlenk flask equipped with a reflux condenser topped with an argon inlet and a Teflon-coated magnetic stirring bar was charged with of (R)-3,5-tBu-MeOBIPHEP (10.0 g, 9.70 mmol) and [Ru(OAc)₂(p-cymene)] (3.8 g, 10.78 mmol). MeTHF (80 mL) was added and the resulting brown suspension was stirred at 85° C. (jacket temperature) for 24 h to reach a conversion of 94% (determined by ³¹P-NMR spectroscopy). The reaction mixture was allowed to cool to rt and concentrated at 100-300 mbar to a volume of 30-40 mL. Hexane (40 mL) was added and the resulting solution was concentrated at 100-300 mbar to a volume of 30-40 mL. This operation was repeated once to remove residual MeTHF. Subsequently, hexane (40 mL) was added and the solution was stirred overnight at rt. The reaction mixture was then heated to 40° C. and filtered on a high porosity glass sintered filter (P3) with a 2-cm pad of pressed filter flocs (MN2101, Macherey-Nagel). The filter cake was rinsed with hexane (30 mL) and the combined filtrates were concentrated at 100-300 mbar/rt to a volume of 30 mL. The resulting dark brown suspension was heated to 60°° C. to deliver a clear solution which was then cooled to 0-5° C. The formed precipitate was filtered off on a high porosity glass sintered filter (P3), the filter cake was washed with hexane (30 mL) and dried overnight at 0.05-0.1 mbar/rt to yield the title compound (9.4 g, 70%) as a yellow solid with 98% purity (determined by ³¹P-NMR) containing 2% (R)-3,5-tBu-MeOBIPHEP.

Optionally, the yellow solid can be recrystallized from hexane at 60° C. (as described above) to yield ³¹P-NMR pure (>99.5%) [Ru(OAc)₂((R)-3,5-tBu-MeOBIPHEP)] (8.8 g, 65% overall yield).

³¹P-NMR (162 MHz, CDCl₃): δ (ppm) 67.5 (s). Residual solvents: MeTHF (0.00 wt % (GC)), hexane (1.15 wt % (GC)), H₂O (<0.1 wt % (Karl Fischer))

### Example 4

### Synthesis of [Ru(OAc)₂((R)-MeOBIPHEP)]

Under argon atmosphere, a 100-mL Schlenk flask equipped with a reflux condenser topped with an argon inlet and a Teflon-coated magnetic stirring bar was charged with of (R)-MeOBIPHEP (5.0 g, 8.58 mmol) and [Ru(OAc)₂(p-cymene)] (3.0 g, 8.58 mmol). MeTHF (40 mL) was added and the resulting brown suspension was stirred at 85° C. (jacket temperature) for 20 h to reach a conversion of >99.5% (determined by ³¹P-NMR spectroscopy). The reaction mixture was allowed to cool to rt and concentrated at 100-300 mbar to a volume of 35 mL. The solution was filtered on a high porosity glass sintered filter (P3) with a 1.5-cm pad of pressed filter flocs (MN2101, Macherey-Nagel). The filter cake was rinsed with MeTHF (15 mL). Hexane (40 mL) was added to the combined filtrates and the resulting dark suspension was cooled in an ice bath and stirred for 1 h. The solid was filtered off on a high porosity glass sintered filter (P3), the filter cake was washed with ice-cold MeTHF (40 mL) and dried for 72 h at 0.05-0.1 mbar/rt to yield the title compound (4.2 g, 61%) as a yellow solid with >99.5% purity (determined by ³¹P-NMR)

³¹P-NMR (162 MHz, CDCl₃): δ (ppm) 63.4 (s). Residual solvents: MeTHF (0.03 wt % (GC)), hexane (0.11 wt % (GC)), H₂O (0.3 wt % (Karl Fischer)).

### Examples 5.1-5.3

### Synthesis of [Ru(OAc)₂((R)-3,5-tBu-4-MeO-MeOBIPHEP)]

In analogy to Example 2, (R)-3,5-tBu-4-MeO-MeOBIPHEP (500 mg, 0.434 mmol) and [Ru(OAc)₂(p-cymene)] (153 mg, 0.434 mmol) were dissolved in 4 ml DCM or MeTHF and the resulting suspensions stirred at the temperatures as stated in Table 1. To determine the conversion at different time points, the reaction mixtures were sampled and analyzed by ³¹P-NMR spectroscopy.

TABLE 1

| | | | Conversion | Conversion | Conversion | Conversion |
|---|---|---|---|---|---|---|
| Example | Solvent | Temp.¹ | after 3 h | after 6 h | after 24 h | after 48 h |
| 5.1 | DCM | 40° C. | 1 | 4 | 13 | 31 |
| 5.2 | MeTHF | 40° C. | 8 | 17 | 45 | 64 |
| 5.3 | MeTHF | 85° C. | 51 | 69 | 90 | 94 |

¹jacket temperature

### Examples 6.1-6.3

### Synthesis of [Ru(OAc)₂((R)-MeOBIPHEP)]

In analogy to Example 4, (R)-MeOBIPHEP (250 mg, 0.429 mmol) and [Ru(OAc)₂(p-cymene)] (151 mg, 0.429 mmol) were dissolved in 4 ml DCM or MeTHF and the resulting suspensions stirred at the temperatures as stated in Table 2. To determine the conversion at different time points, the reaction mixtures were sampled and analyzed by ³¹P-NMR spectroscopy.

TABLE 2

| | | | Conversion | Conversion | Conversion |
|---|---|---|---|---|---|
| Example | Solvent | Temp.¹ | after 3 h | after 6 h | after 24 h |
| 6.1 | DCM | 40° C. | 51 | 71 | 96 |
| 6.2 | MeTHF | 40° C. | 76 | 86 | 96 |
| 6.3 | MeTHF | 85° C. | 98 | 99 | — |

¹jacket temperature

1. A process for the preparation of a [Ru(OAc)₂(Ligand)] catalysts of the formula I and its enantiomers, 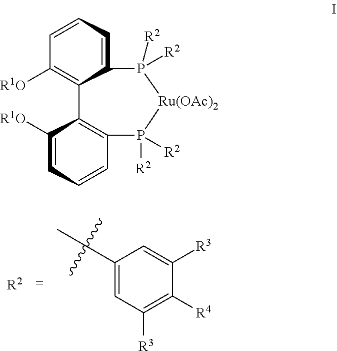
wherein R¹ is C₁₋₆ alkyl and R³is hydrogen or C₁₋₆ alkyl and R⁴ is hydrogen or C₁₋₆-alkoxy,
comprising the conversion of a phosphine precursor of the formula II 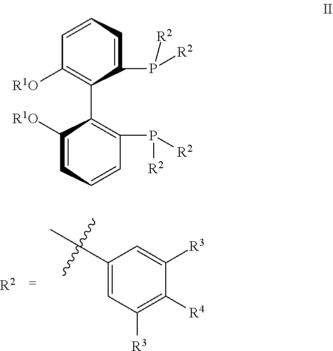
wherein R¹, R³ and R⁴ are as above,
with [Ru(OAc)₂(p-cymene)], wherein Ac stands for acetyl,
to the [Ru(OAc)₂(Ligand)] catalyst of the formula I
in the presence of a non-polar solvent at a reaction temperature of 40° C. to 110° C.

2. The process of claim 1, wherein R¹ is methyl.

3. The process of claim 1, wherein R³ is C₁₋₄-alkyl, preferably t-butyl.

4. The process of claim 1, wherein R⁴ is hydrogen or C₁₋₄-alkoxy, preferably hydrogen or methoxy.

5. The process of claim 1, wherein the non-polar solvent is selected from tetrahydrofuran, toluene, benzene, 1,4-dioxane and 2-methyltetrahydrofuran, preferably from 2-methyltetrahydrofuran.

6. The process of claim 1, wherein the reaction temperature is between 40° C. and 110° C.

7. The process of claim 1, wherein the conversion is conducted under inert gas atmosphere.

8. The process of claim 1, wherein the [Ru(OAc)₂(Ligand)] catalysts of the formula I are isolated by a solvent exchange wherein the non-polar solvent is replaced by and anti-solvent.

9. The process of claim 8, wherein the anti-solvent is selected from the group consisting of liner C₅₋₁₀ alkanes and branched C₅₋₁₀ alkanes.

10. The process of claim 8, wherein the wherein the anti-solvent is selected from the group consisting of n-pentane, n-hexane, and n-heptane.
